(19) United States
(12) Patent Application Publication
(10) Pub. No.: US 2009/0263770 A1
(43) Pub. Date: Oct. 22, 2009

(54) SYSTEM AND METHOD FOR SIMULATING HAZARDOUS ENVIRONMENTS FOR PORTABLE DETECTION METERS USED BY FIRST RESPONDERS

(76) Inventor: Philip L. Ambrose, Rolling Hills Estates, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/389,284

(22) Filed: Feb. 19, 2009

Related U.S. Application Data
(60) Provisional application No. 61/030,177, filed on Feb. 20, 2008.

(51) Int. Cl. G09B 9/00; G09B 19/00

(52) U.S. Cl. 434/218; 434/226

(57) ABSTRACT

The system and method for simulating hazardous environments provides simulated meter readings of hazardous environment for training first responder entry teams by controlling a simulated display provided to portable detection meters, such as via a wireless interface. The simulator provides meter reading displays for selected environments and allows for two-way interactive response. A master control unit allows direct control of individual meter displays and scenarios representing various hazardous environments. A hazardous environment is reflected by parameters indicating the presence of hazardous substances, and the apparatus can be implemented by external placement on current meters, as part of a general training meter, or using technology to internally control existing meters.

### CROSS-REFERENCES TO RELATED APPLICATIONS

This application is based upon Provisional Application No. 61/030,177, filed Feb. 20, 2008, which is incorporated by reference herein in its entirety.

### BACKGROUND OF THE INVENTION

The invention is related to a system of simulating readings on portable detection devices through both hardware device and software to provide simulated immediately dangerous to life and health (IDLH) environments for hazardous materials (HazMat) first responder training.

Currently there are few options for effective and realistic hands-on training with the many meters made by various manufacturers. Post-9/11, we have seen a tremendous increase in the number of handheld hazardous materials detection instruments for Chemical, Biological, Radioactive, Nuclear, and Explosive (“CBRNE”) environments. Proper interpretation of and reaction to data received on detection meters is vital to life safety (evacuations, suit compatibility, IDLH) in a hazardous atmosphere or HOTZONE. Technology applied to the development of HazMat meters has increased their functionality but technology to train users on these meters has not advanced at the same pace. Additionally, the number of new first responders requiring training, including those from outside traditional emergency response agencies, has increased multi-fold. This training deficiency puts first responders at risk when an actual incident occurs.

Emergency response agencies from all over the United States utilize grant funds to send personnel to a handful of remote training sites that specialize in certain areas of CBRNE. Those offsite training opportunities result in increased cost to cover personnel with only marginal benefit, given the limited exposure to live agent hands on training. The hazardous materials meter simulator of the invention would allow better, more effective training to be conducted locally at a fraction of the cost of present methods.

Live fire training (e.g., active burns creating an IDLH atmosphere) in the Fire Service are used to establish vital real-life and safety decision skills in an environment that approximates the responder's real world as closely as possible. However, this same model of live training in HazMat, using actual CBRNE agents for training HazMat first responders, is dangerous, expensive, difficult to construct, and unrealistic for most, if not all, municipal fire/hazmat teams. The live agents that are used are typically very small amounts in a controlled environment that does not simulate actual distribution of the substance, initial contact with or training stress likely experienced in the field. The HazMat response service needs the ability to train front line responders with realistic and real-time simulations on their detection devices. The hazardous materials meter simulator of the present invention would use existing technology to create realistic and controlled responses on the detection meter without the use of CBRNE. Because the hazardous materials meter simulator of the invention will provide a more realistic reading, a trainee or experienced HazMat responder using the hazardous materials meter simulator of the invention would more likely pay closer attention to the meter response as well as experience critical decision-making in the simulated HOTZONE.

This system allows local fire, police, and emergency response agencies to set up effective life safety training anywhere and at any time without traveling from their district or being exposed to any real hazardous materials. Nationally accepted protocols and local Policy and Procedure could be adapted easily into the training scenarios. Local jurisdictions would be able to set up realistic trainings easily at their own ‘Target Hazard’ locations.

### SUMMARY OF THE INVENTION

Briefly, and in general terms, the present invention provides for a training simulation device and method for improving life-safety skills in the response to hazardous incidents by first responders using computer interface, wireless technology, simulation software, simulation data and meter parameters to replicate a hazardous environment without the use of hazardous substances. The system integrates chemical, radioactive, and other hazardous substance parameters to closely replicate a hazardous environment.

The present invention provides a computer based simulation training system for improving the response to actual hazardous incidents by first responders. The system includes a master control, peripheral devices, and a software module that can be used on laptop, portable, or PDA computer devices which are used at a training scenario to simulate a hazardous atmosphere in real time. The present invention can be used to provide direct manipulation of the peripheral devices or control via a group simulation environment. This system integrates the specific technical functions and readings of various detection meters currently on the market that are used to measure chemical, biological, radiological, energetic, or other hazards, or a combination of two or more hazards. In the group simulation environment, the present invention will emulate the simulated environment throughout multiple devices by controlling each separate parameter.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a flow chart illustrating master control of three types of hazardous materials meter simulators of the invention, by direct control of an individual peripheral apparatus, group control of multiple peripheral apparatus, and control of multiple apparatus by programs or combination of programs reflecting selected environmental settings, such as for dirty bomb contamination, an oxygen deficient environment, and chlorine contamination.

FIG. 2a illustrates the features of the embodiment of the hazardous materials meter simulator implemented as an external display attached to a meter.

FIG. 2b illustrates the features of the embodiment of the hazardous materials meter simulator implemented as control of an internal display of a meter.

FIG. 2c illustrates the features of the embodiment of the hazardous materials meter simulator implemented as a stand alone interactive training meter.

FIG. 3 is a schematic diagram of a hazardous materials meter simulator master control unit implemented as a PDA, notebook, or PC tablet containing software and hardware that controls one or more peripheral units.

FIG. 4 is a schematic diagram of a hazardous materials meter simulator master control unit operated by a remote touch screen.

FIG. 5 is a schematic diagram of the hazardous materials meter simulator master control unit and a peripheral hazardous materials meter simulator unit attached to a hazardous materials meter for training HazMat teams.

### DETAILED DESCRIPTION OF THE PREFERRED EMBODIMENTS

In the following detailed description of the embodiments, reference is made to the accompanying drawings, which form a part hereof, and which are presented by way of illustration, and not by way of limitation. These embodiments are described in sufficient detail to enable those skilled in the art to practice the invention, and it is to be understood that other embodiments may be utilized, and that structural, logical and electrical changes may be made without departing from the spirit and scope of the present invention.

The hazardous materials (HazMat) meter simulator 10 enables a display, either externally attached or as part of the unit, to mimic a hazardous atmosphere environment for training purposes. Hazardous materials meter simulator enabled devices are able to have their display controlled remotely with the intention of simulating various modes of the detection device in all atmospheres. A hazardous materials meter simulator interactive hazardous simulation training involves a control unit, which wirelessly controls the display on each remote unit. A hazardous materials meter simulator enabled meter allows its display to be controlled remotely for training purposes.

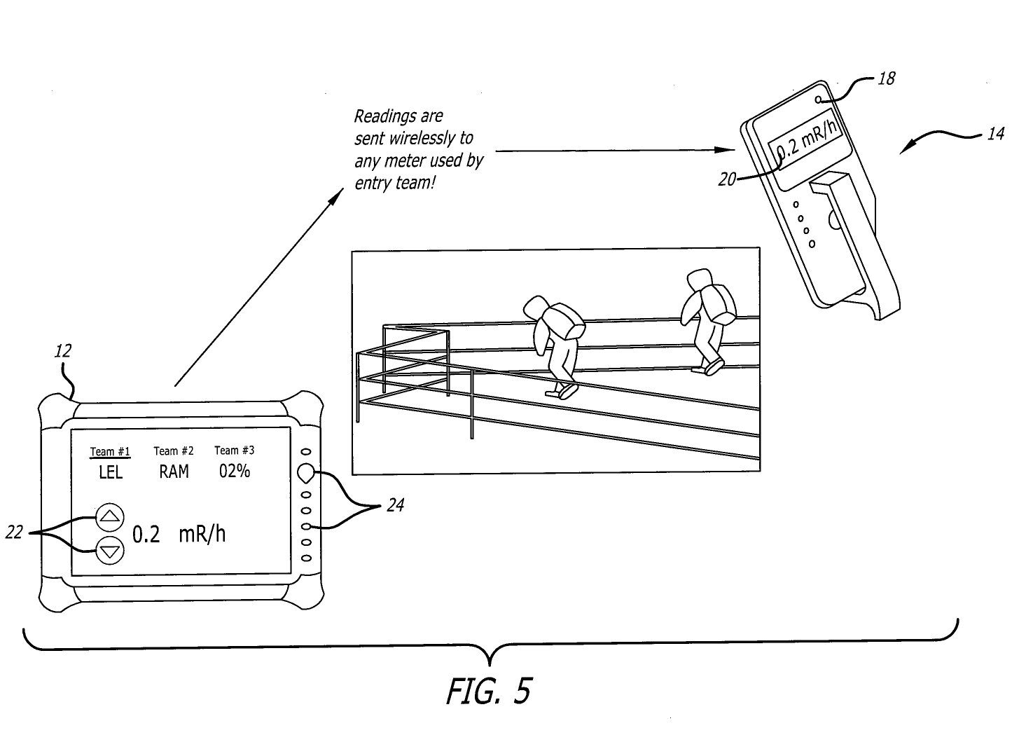

The hazardous materials meter simulator master control unit 12 is the main computer enabled control device (PDA, notebook, tablet) 28 containing software 30 and hardware that controls one or more peripheral hazardous materials meter simulator units 14, 16. The control unit is based within a ruggedized tablet or PDA device capable of sending wireless signals to one or more of the remote hazardous materials meter simulator devices. Optionally the control unit would receive data from the interactive training mode via remote unit touch screen 20. The operations screen on the control unit as shown in the accompanying FIG. 5 would indicate which meter it was controlling, what type of meter, and a display of the meter. Touch screen ‘toggles’ or buttons 22 would be visually displayed and when pressed would send a signal to the remote hazardous materials meter simulator's changing their display. The control unit would optionally have direct buttons 24 for a ‘type’ of environment 13 to be sent to all meters as a group. For instance: by pressing a button called dirty bomb—the rad meters would pick up RAM, and any LEL meter may pick up residual atmosphere related to an explosion. More specifically, a meter could be directly controlled with a simple up or down arrow and the ability to change the rate and/or increment of change.

The hazardous materials meter simulator peripheral unit can be the hazardous materials detection device or meter itself, or can be an attachment 18 to such a device/meter for the end user. The master control unit controls this device/meter or attachment, replacing the display on a meter. When implemented as an attachment, the peripheral unit is typically an approximately 3″×5″ external device that is attached over the detection meter's display. The display mimics the actual display of the meter on which it is placed. The hazardous materials meter simulator is completely independent of the meter but during training the user reads the hazardous materials meter simulator display. Built-in memory files preprogrammed of the actual meter's display are controlled via wireless interface (“wifi”) 26 from a master training hazardous materials meter simulator handheld device. The master hazardous materials meter simulator changes the display on the training meter to reflect various environments/readings. The advantage to this approach is that the hardware and software requirements including wifi are currently available and there is no need to infiltrate the meter and its proprietary specifications. The user gets an actual reading on the display and needs to take necessary actions. The hazardous materials meter simulator could not be mistaken for an actual meter. The master hazardous materials meter simulator could operate multiple hazardous materials meter simulators simultaneously.

The external device for attachment to a meter is made within a ruggedized shock proof/water resistant plastic case consisting typically of a display (LCD) on one side (touch screen option on certain models), a battery, a memory, power switch, microprocessor, wireless Rx (TX option), and an external USB interface port.

Display

The display screen is on one side of the unit as indicated in drawings. The display will be specified to be scratch resistant and weather proof. The display will have adequate resolution to show meter function images. The screen will have adequate glare resistance and backlighting ability. Color is optional, based on cost.

Battery

The battery will supply enough voltage to run the CPU 28 and screen for extended periods between charging and/or battery replacement. Intrinsically safe operation is not required. The system can have an optional external charge port.

Memory

The memory is capable of storing screen shots and active screen movies (looped) of each selected meter function. The files are stored based on meter type, model, manufacturer, and desired display. When called upon by the CPU, the memory file will be displayed on the screen.

Microprocessor (CPU)

The processor 28 will need the ability to interface with the wireless signal and pull the appropriate file from memory to be displayed on the screen. Optionally the CPU will be required to take touch screen input from the screen and wirelessly return the data to the control unit. The CPU will receive power and initiate activity upon activation of the power switch.

Power Switch

Externally located on the side of the unit. Water resistant/proof.

External Ports

External battery charge and or optional docking, data port to cpu/memory for updating files and downloading data. Additional ports as needed.

Hazardous Materials Meter Simulator Software Design:

Interactive Training Component:

Software 30 controls the control unit, the peripheral units, and their interaction. The control unit displays and controls all of the controls on the peripheral units. Features include:
Direct control of peripheral units
Scenario control of multiple peripheral units
Interactive feature and data logging
Internal control of peripheral unit

Direct Control of Peripheral Units

This feature allows the control unit to directly control via buttons or touch toggles the display on the peripheral unit. An input (e.g. Increase mR/hr) given on the control unit sends a wireless transmission to the peripheral unit. The peripheral unit receives the signal, which is translated into displaying the appropriate image or video on the display.

Scenario Control (Including Control of Multiple Peripheral Units)

This feature allows a training officer, typically one or more persons that would use the hazardous materials meter simulator master control unit and peripherals for the purpose of training personnel in a simulated environment, to select a type of environment via the master control. This environment ‘group’ will trigger each peripheral device appropriately to simulate a potentially complex environment. Multiple peripheral devices are used at the same time and each will respond appropriately. The types of scenario environments may include, but are not limited to, normal background, radioactive, chemical, explosive, and any combination thereof.

The software first operates to find out how many and what type of meters are going to be used in the scenario; more can always be added. The peripheral meters are set as a group. Instead of direct control of each individually, the training officer can select an overall environment (i.e., post blast of dirty bomb). A time component is necessary to set up the scenario. At the start of the scenario, realistic readings for each type of meter are given (this is also preselected) and over time, each may change. The scenario may be location based, including the location of the meter, as determined by a global positioning system, for example, and will determine readings throughout the training. Overall this feature will make management of multiple meters easier for one training officer. Meter response can also be controlled by the type of hazard in this group mode (as compared to a direct change of reading). During training, radio contact can be used to determine participant understanding of the simulated environment.

Meters controlled individually, or as a group, or as an environment group/type, and may change based on time, or location or direct input. Custom environments can be created, including the parameters in the following table:

Parameters

Oxygen Percent
H₂S ppm
CH₄ LEL (lower explosive limit) vol percent
CH₄ LEL (lower explosive limit) percent
RAM (radioactive material) Beta
RAM (radioactive material) Gamma
RAM (radioactive material) Alpha
Chlorine ppm
CO ppm
G (nerve agent)
V (nerve agent)
B (nerve agent)
H (nerve agent)
T (mustard gas additive)
Phosgene
Custom

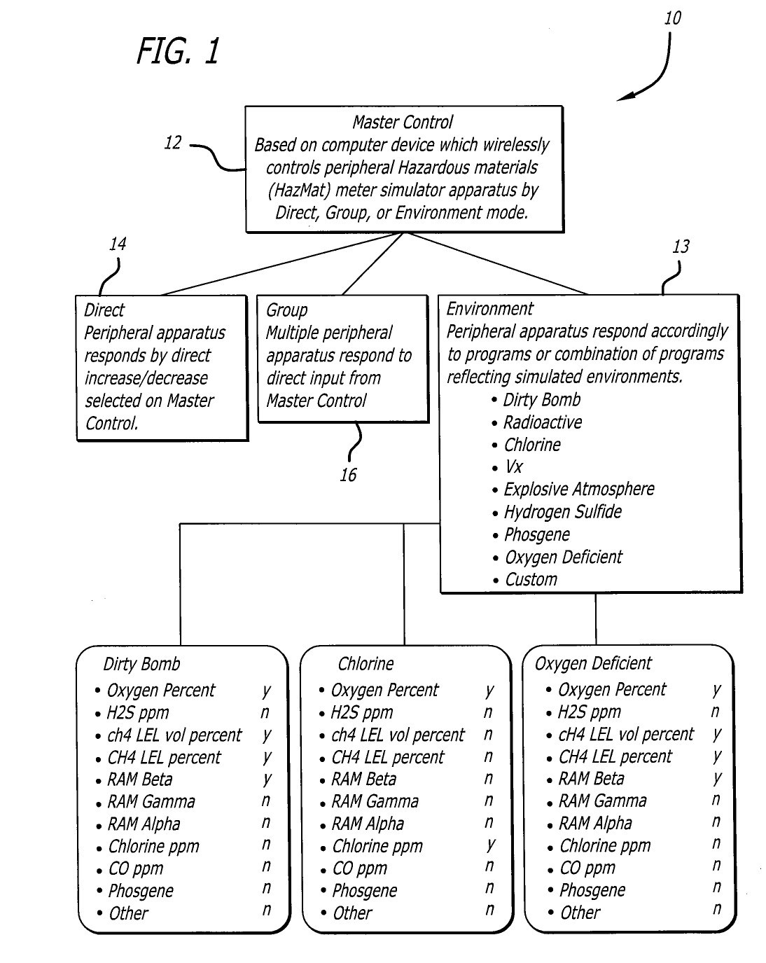

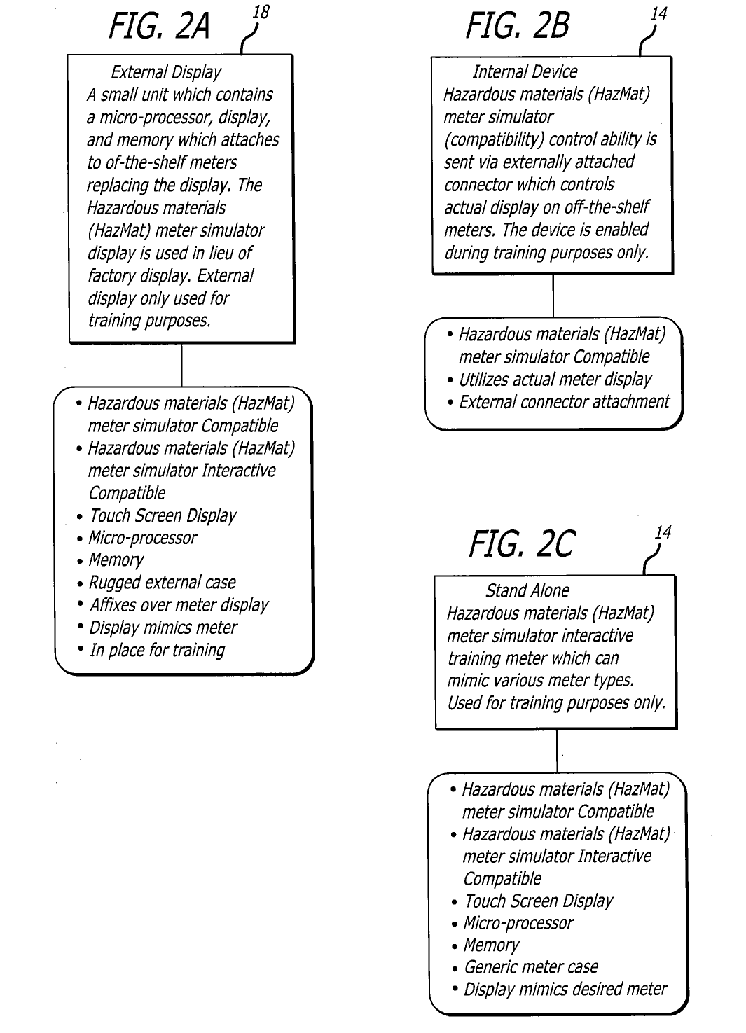

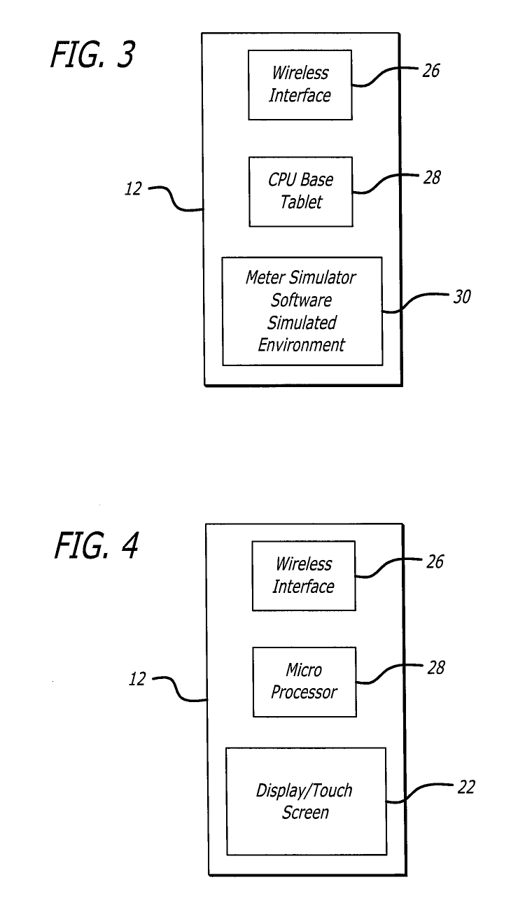

The participating teams utilizing the peripheral device will obtain simulated readings on their detection instrumentation thus experiencing the critical decision making experience in real time. The display will mimic exactly what is desired by the master control unit. FIG. 1 illustrates master control for three ways of implementing the hazardous materials meter simulator of the invention, by direct control of an individual peripheral apparatus, group control of multiple peripheral apparatus, and control of multiple apparatus by programs or combination of programs reflecting selected environmental settings, such as for dirty bomb contamination, an oxygen deficient environment, and chlorine contamination.

The master control meter utilizes the hazardous materials meter simulator software 30 on a computer device (tablet, notebook) 28 and is used by the training officer to control the peripheral meters held by the first responder. The master control sends a wireless signal to the peripheral devices in order to change the display to match what is desired from the master control.

The peripheral control may be implemented in three different ways: (1) An external attachment display device may be provided containing a display screen with touch ability, ruggedized case, internal power supply, internal cpu, internal memory. The internal CPU receives direction from a wireless signal from a master control unit cueing the display of the desired memory file that mimics the desired meter function. (2) The hazardous materials meter simulator may be implemented by direct control from a master control unit of an internal display of a meter. (3) The hazardous materials meter simulator may be implemented as a specialized stand-alone interactive training meter.

In the group simulation environment, the present invention will emulate the simulated environment throughout multiple devices by controlling separate parameters, such as mR/hr as measured by a radioactive materials detector, such as the detector available from Ludlum Measurements, Inc., of Texas, for measuring beta and gamma radiation, for example, or such as the parameters listed in the following table.

| Parameter | Environment | Normal Range |
|---|---|---|
| CH₄ | LEL vol percent | TBD |
| CH₄ | LEL percent | TBD |
| O2 | Oxygen Deficient/Sat | TBD |
| CO | Carbon Monoxide | TBD |
| H₂S | Hydrogen Sulfide | TBD |
| mR/hr | Radiation | TBD |
| Chlorine | Chlorine | TBD |
| Phosgene | Phosgene | TBD |
| Vx (nerve agent) | | TBD |
| G/B/H (nerve agents) | | TBD |
| Pepper Spray | | TBD |
| cpm | | TBD |

It will be apparent from the foregoing that while particular forms of the invention have been illustrated and described, various modifications can be made without departing from the spirit and scope of the invention. Accordingly, it is not intended that the invention be limited, except as by the appended claims.

I claim:

1. A hazardous materials meter display simulator apparatus, comprising:
a master control unit for determining a selected plurality of parameters and values to reflect a selected environmental and contamination condition;
at least one peripheral meter display unit configured to receive and display said selected plurality of parameters and values to reflect said selected environmental and contamination condition.

2. The hazardous materials meter display simulator apparatus of claim 1, wherein said at least one peripheral meter display unit comprises a plurality of peripheral meter display units, and said master control unit is operative to provide group control of said plurality of peripheral meter display units.

3. The hazardous materials meter display simulator apparatus of claim 1, wherein said at least one peripheral meter display unit comprises a plurality of peripheral meter display units, and said master control unit is operative to provide control of said plurality of peripheral meter display units by at least one program reflecting said selected environmental and contamination condition.

4. The hazardous materials meter display simulator apparatus of claim 1, wherein said at least one peripheral meter display unit comprises an attachment unit configured to be attached over a display of a portable hazardous material detection device.

5. The hazardous materials meter display simulator apparatus of claim 1, wherein said master control unit is configured to allow a user to select a number of peripheral meter display units to be controlled, a type of hazardous materials detection meter to be simulated, a type of environment which at least one peripheral meter display unit will simulate, and to select the parameters to be controlled.

6. The hazardous materials meter display simulator apparatus of claim 1, wherein said at least one peripheral meter display unit comprises a display screen that mimics a chosen portable detection meter selected by the master control unit.

7. The hazardous materials meter display simulator apparatus of claim 1, wherein said at least one peripheral meter display unit comprises a touch screen configured to prompt a user to respond to critical decision making questions based on local and recognized policy.

8. A method for simulating hazardous environments for portable detection meters for detecting hazardous materials, comprising:
providing a master control unit and determining a selected plurality of parameters and values to reflect a selected environmental and contamination condition with said master control unit;
providing at least one peripheral meter display unit configured to receive and display said selected plurality of parameters and values to reflect said selected environmental and contamination condition; and
displaying said selected plurality of parameters and values to reflect said selected environmental and contamination condition on said at least one peripheral meter display unit.

9. The method of claim 8, wherein said at least one peripheral meter display unit comprises a plurality of peripheral meter display units, and said master control unit is operative to provide group control of said plurality of peripheral meter display units.

10. The method of claim 8, wherein said at least one peripheral meter display unit comprises a plurality of peripheral meter display units, and said master control unit is operative to provide control of said plurality of peripheral meter display units by at least one program reflecting said selected environmental and contamination condition.

11. The method of claim 8, wherein said at least one peripheral meter display unit comprises an attachment unit configured to be attached over a display of a portable hazardous material detection device.

12. The method of claim 8, further comprising the step of operating said master control unit to select a number of peripheral meter display units to be controlled.

13. The method of claim 8, further comprising the step of operating said master control unit to select a type of hazardous materials detection meter to be simulated.

14. The method of claim 8, further comprising the step of operating said master control unit to select a type of environment which at least one peripheral meter display unit will simulate.

15. The method of claim 8, further comprising the step of operating said master control unit to select the parameters to be controlled.

16. The method of claim 8, wherein said at least one peripheral meter display unit comprises a display screen that mimics a chosen portable detection meter selected by the master control unit.

17. The method of claim 8, wherein said at least one peripheral meter display unit comprises a touch screen configured to prompt a user to respond to critical decision making questions based on local and recognized policy.
